(19) United States
(12) Patent Application Publication
(10) Pub. No.: US 2008/0036854 A1
(43) Pub. Date: Feb. 14, 2008

(54) Method and system of communicating and rendering stereoscopic and dual-view images

(75) Inventors: Keith H. Elliott, Plano, TX (US); David C. Hutchison, Plano, TX (US); Henry W. Neal, Allen, TX (US); Bradley W. Walker, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/647,819

(22) Filed: Dec. 29, 2006

Related U.S. Application Data
(60) Provisional application No. 60/821,805, filed on Aug. 8, 2006.

(51) Int. Cl. H04N 13/04

(52) U.S. Cl. 348/55

(57) ABSTRACT

A method and system for communicating and rendering stereoscopic or dual-view images are provided. In one embodiment, a method rendering stereoscopic images includes alternating, on a display, left and right perspectives of an image. Each of the left and right perspectives corresponds to a respective array of pixels on the display such that the left perspective is offset from a right perspective by less than a pixel width. The method further includes shuttering a portion of the light provided from the display in sequence with the alternating of the left and right perspectives if the image.

### RELATED APPLICATION

The present application claims the benefit of U.S. Provisional Patent Application No. 60/821,805, filed on Aug. 8, 2006, which is hereby incorporated by reference.

### TECHNICAL FIELD

This invention relates in general to display systems and, in particular, to display systems having enhanced three-dimensional or dual-view capabilities.

### BACKGROUND

Stereoscopic images generally represent views of a particular scene from two perspectives such as from the right eye and left eye of a viewer. Having this capability can provide the perception of depth to the viewer. In other words, stereoscopic images imply rendering separate images for the left and right eyes to create the illusion of three-dimensional depth. Conventional stereoscopic solutions are not very efficient at transporting and displaying stereoscopic images for a variety of reasons.

### SUMMARY OF THE EXAMPLE EMBODIMENTS

A method and system for communicating and rendering stereoscopic or dual-view images are provided. In one embodiment, a method rendering stereoscopic images includes alternating, on a display, left and right perspectives of an image. Each of the left and right perspectives corresponds to a respective array of pixels on the display such that the left perspective is offset from a right perspective by less than a pixel width. The method further includes shuttering a portion of the light provided from the display in sequence with the alternating of the left and right perspectives of the image.

Technical advantages of some embodiments of the invention may include a method and system for communicating and rendering a stereoscopic display having enhanced performance and efficiency at low cost. Some embodiments may provide a very bandwidth-efficient method of communicating the spatial resolution of stereoscopic images. In addition, various embodiments may integrate well with existing hardware and software systems with minimal modifications.

It will be understood that the various embodiments of the present invention may include some, all, or none of the enumerated technical advantages. In addition other technical advantages of the present invention may be readily apparent to one skilled in the art from the figures, description, and claims included herein.

### BRIEF DESCRIPTION OF THE DRAWINGS

For a more complete understanding of the present invention and features and advantages thereof, reference is now made to the following description, taken in conjunction with the accompanying drawings, in which:

FIG. 1 is a block diagram illustrating a system for capturing and encoding the left and right images of a stereoscopic image according to one embodiment of the present disclosure;

FIG. 2 is a block diagram illustrating a display system operable to render a stereoscopic display using the encoded images of FIG. 1 according to one embodiment of the present disclosure; and

FIG. 3 is a block diagram illustrating an alternative display system operable to render a stereoscopic display using a variety of inputs according to one embodiment of the present disclosure.

### DESCRIPTION OF EXAMPLE EMBODIMENTS

In accordance with the teachings of the present disclosure, a method and system for communicating and rendering stereoscopic or dual-view images are provided. Various embodiments may provide the perception of three-dimensional depth to a viewer. Some dual-view embodiments may use the time-sequenced display of dual images to generate two unrelated video streams to respective viewers. Particular examples specified throughout this document are intended for example purposes only, and are not intended to limit the scope of the present disclosure. In particular, this document is not intended to be limited to a particular technology, such as SmoothPicture™ technology.

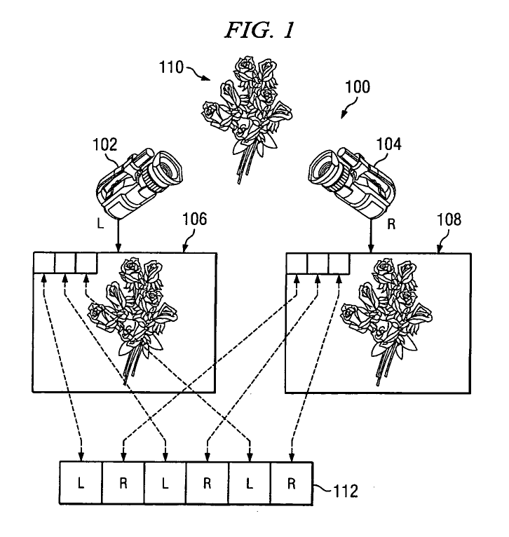

FIG. 1 is a block diagram illustrating a system 100 for capturing and encoding the left and right images of a stereoscopic image according to one embodiment of the present disclosure. In the example embodiment, system 100 generally includes two digital video cameras 102 and 104 operable to capture and encode respective images 106 and 108 of an object 110 from left and right perspectives respectively. As explained further below, these left and right perspectives may be used to create the illusion of three-dimensional depth in a photograph, movie, or other two-dimensional image by presenting them to respective eyes of a viewer.

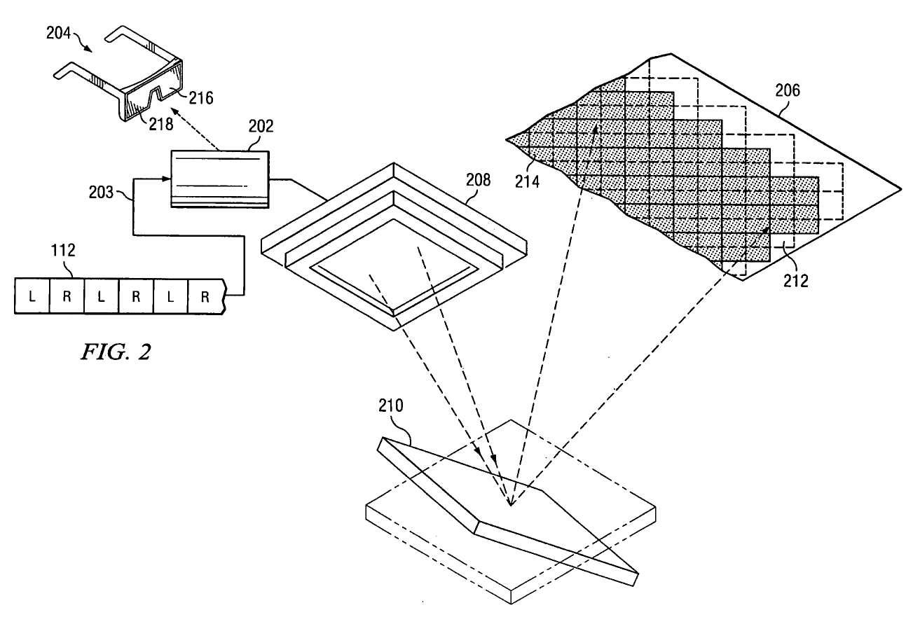

In the example embodiment, the pixel components of left and right images 106 and 108 are encoded in a data stream 112 in an alternating pattern. Although the example embodiment encodes left and right images 106 and 108 row by row in descending order, other embodiments may encode left and right images in any appropriate manner, such as, for example, column by column. Data stream 112 may be encoded using a checkerboard format, such that a particular encoded row commencing with a pixel component from the left image 106 is followed by an encoded row commencing with a pixel component from the right image 108. In various embodiments, this manner of encoding may facilitate the rendering of stereoscopic images using existing hardware and software platforms, as explained further with reference to FIG. 2.

FIG. 2 is a block diagram illustrating a display system 200 operable to render a stereoscopic display using the encoded images 106 and 108 of FIG. 1 according to one embodiment of the present disclosure. In the example embodiment, display system 200 is generally capable of rendering three-dimensional images by synchronizing the sequential display of left and right images 106 and 108 of stereoscopic data stream 112 to corresponding left and right eyes of a viewer. To effect the perception of three-dimensional depth, display system 200 generally includes a processor 202 operable to synchronize the stereoscopic shuttering of one or more pairs of glasses 204 to a particular stereoscopic image 106 and 108 displayed on surface 206. In addition, in some embodiments, display system 200 may include one or more light modulators 208 each operable to direct light to an optical actuator 210, all communicatively coupled to processor 202. As explained further below, in some embodiments, light modulator 208 and optical actuator 210 may be substantially similar to respective hardware components used for SmoothPicture™ technology developed by Texas Instruments Incorporated.

Processor 202 generally refers to any suitable rendering engine. In the example embodiment, processor 202 is operable to receive data stream 112, which contains alternating sampled data corresponding to full resolution left and right images 106 and 108. In some embodiments, processor 202 may receive data stream 112 using conventional interfaces 203 typical of non-stereoscopic images. Examples of such interfaces 203 include DVI, HDMI, LVDS, iTMDS, or some other suitable interface. In various embodiments, this manner of encoding and communication may integrate well with existing systems with minimal modifications. For example, this particular embodiment may integrate well with SmoothPicture™ hardware and processing algorithms, developed by Texas Instruments Incorporated, examples of which are described in Ser. No. 10/752,858 entitled METHOD AND APPARATUS FOR INCREASING A PERCEIVED RESOLUTION OF A DISPLAY, which are incorporated herein by reference.

Processor 202 may recombine the full-resolution data of the left image 106 received from data stream 112 into a first sub-frame 212 while the right image 108 is displayed in the second sub-frame 214, or vice-versa. For an input frame-rate of 60 Hz, processor 202 may use 120 Hz sub-frame processing to update each eye at that 60 Hz rate; however, other frequencies may be used. In this manner, data stream 112 may be received and processed with little or no changes to SmoothPicture™ hardware and software.

In general, the left and right components of a stereoscopic image may be alternatively displayed on a surface 206 in rapid succession to create the perception of simultaneous display to a viewer. Multiple stereoscopic images displayed sequentially in this manner may form a video stream. Processor 202 is generally operable to synchronize the sequential timing of the left and right image components with respective shutters 216 and 218 of glasses 204 to effect the perception of three-dimensional depth, by outputting a synchronization signal.

Glasses 204 generally refer to any suitable device capable of temporarily shuttering or substantially blocking out light provided to the wearer's eyes from surface 206. To illustrate, shutter 216 may block the view of the left eye while shutter 218 allows the right eye to see the display of right image 108 on surface 206. The shuttering synchronization may be effected by any of a variety of methods. For example, an infrared (IR) emitter can send the command to glasses 204 to switch. The IR emitter may be synchronized to the sub-frame signal of processor 202. In an alternative implementation, the IR emitter can also include a delay capability. Other embodiments may include an initial synchronization stage while glasses 204 are docked at a station (not explicitly shown) that is hardwired to processor 202.

Glasses 204 may shutter light received from display surface 206 by any of a variety of methods. For example, each shutter 216 and 218 may include mechanical, electromechanical, or electrical optical shutters, such as, for example, liquid crystal panels. If brightness is compromised because of transmission loss and polarization effects, some type of brightness compensation effect can be used. A reduction in brightness can be caused by the shutter mechanism of glasses 204. The transition time used by the glasses may be a significant amount of time out of the total available time. The display output may have to be turned off during this transition time. If glasses 204 with a faster transition time are used, this “dark time” came be reduced and the images may be brighter. In addition, the material properties of glasses 204 may further reduce brightness. For example, some glasses 204 may have polarization properties in addition to simple transmission losses. Therefore, brightness can be enhanced by using shutter mechanisms with better material properties.

In various embodiments, software modifications may further enhance the rendering of stereoscopic images. For example, a color processing sequence with a three-dimensional mode may be used. A “dark time” of a few milliseconds (e.g., 2 ms, 1 ms or the like) for each sub-frame can be used to reduce or eliminate smearing or ghosting, which is an additive combination of left and right images due to slow switching times of the glasses 204. The smearing or ghosting effect may be reduced further, for example, by implementing a specific method of updating the data displayed on surface 206 so that it turns off the output during the shutter mechanism's transition time.

Another software modification may include disabling spatial processing (e.g., scaling, sharpening filters, or the like) that can be done after the left and right images 106 and 108 are combined into the specific stereoscopic format used. Eliminating this kind of processing can ensure that the left and right data remains separated so that there can be a three-dimensional effect. Such techniques may be adaptable to higher-speed methods of separating the left and right images, which may further improve the performance and quality of picture even with the same system input. Various embodiments may potentially retrofit existing displays with this stereoscopic capability with no additional hardware costs.

Surface 206 generally refers to any suitable display surface, such as, for example, a television screen or a computer screen. In some embodiments, display system 200 may support any of a variety of picture resolutions for display on surface 206. For example, display system 200 may support the following resolutions: 640×480 p (PC gaming), 800×600 p (PC gaming), 1280×720 p (PC, Broadcast), 1024×768 p (PC Gaming), 1280×800 p (PC Gaming), 1280×1024 p (PC Gaming), 1400×900 p (iMac Gaming), 1600×1200 p (PC Gaming), 1680×1050 p (iMac Gaming), 1920×1080 p (PC Broadcast). Moreover, all of the other alternatives mentioned below with regard to HDMI and DLP® TV are equally applicable. Such embodiments may or may not include light modulator 208 and associated optical actuator 210. In the example embodiment, however, surface 206 is a projector screen operable to receive and display an image received from light modulator 208.

Light modulator 208 generally refers to any suitable device(s) operable to spatially modulate light. For example, light modulator 208 may be a liquid crystal display, a liquid crystal on silicon display, or an interferometric modulator. In the example embodiment, however, light modulator 208 is a deformable micromirror device (DMD), sometimes known as a digital micromirror device. Light modulator 208 is operable to selectively communicate received light beams to display surface 206 in response to signals provided by processor 202. The light modulator 208 of this particular embodiment is an offset sampling DMD, which includes individual pixels that are diamond shaped or rotated forty-five degrees with respect to the edges of the image array; however other pixel configurations may be used.

Optical actuator 210 generally refers to any device operable to communicate with light modulator 208 such that each of light modulator pixel corresponds to multiple display pixels on surface 206. Although the example embodiment effects this resolution enhancement using existing SmoothPicture™ hardware, any suitable hardware may be used. In the example embodiment, optical actuator 210 reflects the optical output of light modulator 208 between two positions separated by a half a pixel height (either vertically or horizontally). In this manner, optical actuator 210 effectively doubles the resolution capability of light modulator 208.

Thus, in the example embodiment, the full resolution of left and right images 106 and 108 are alternatively displayed at relatively offset positions 212 and 214. For example, image 106 may be displayed at a first position 212 and image 108 may be displayed at a second position 214, both display positions 212 and 214 effected by the same pixel array of light modulator 208. In some embodiments, this may result in a better image due to the eye's ability to rejoin the portions of the original image back together and the resultant cancellation of pixel boundaries. Although the example embodiment uses an optical actuator to effect multiple displayed pixels for each light modulator 208 pixel, other embodiments may use other methods, such as, for example, an acoustooptic device.

Conventional methods of rendering stereoscopic images use a variety of formats including, line interleaved, column interleaved, and frame interleaved formats. To illustrate, a conventional line interleaved format typically dedicates an entire horizontal line to either the left or right image component of a stereoscopic image. Thus, each component makes up half of the total stereoscopic image resolution. To avoid incurring additional cost in interface components, most stereoscopic solutions will split the normal transport interface bandwidth between the left and the right stereoscopic images. Consequently, many conventional stereoscopic solutions sacrifice horizontal or vertical resolution. In addition, many conventional methods assume orthogonal imaging grids to render the image. Therefore, these methods are not very efficient at communicating and displaying stereoscopic images in systems that use spatial light modulators, such as, for example, DLP® TVs or DLP® projectors.

Accordingly, the teachings of some embodiments of the present invention recognize a method and system for communicating and rendering a stereoscopic display having an enhanced performance and efficiency at low cost. Some embodiments may render stereoscopic images by combining the use of alternating image encoding and the subsequent separation of the left and right images using a sub-frame interleaving approach. This combination may provide a very bandwidth efficient method of communicating the spatial resolution of stereoscopic images. In addition, various embodiments may integrate well with existing hardware systems with minimal modifications. As described previously, systems using SmoothPicture™ technology is but one example.

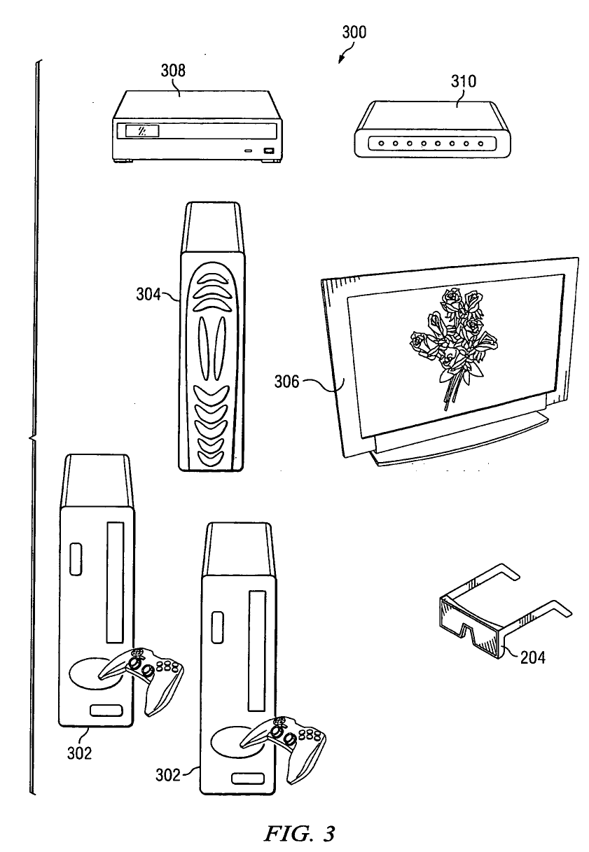

The use of alternating image encoding, or offset sampling of images 106 and 108, is one of the most efficient approaches for stereoscopic image content, because it maximizes the image quality for a given bandwidth. In addition, the offset sampling can also operate at higher speeds in order to improve the overall resolution to each eye and reduce or eliminate flicker artifacts. The resulting display format provides an optimal bandwidth implementation that maximizes spatial resolution content of the stereoscopic image. In addition, the human visual system may blur the boundaries of overlapping pixels, thereby reducing pixilation. In some embodiments, the use of a diagonal pre-filter algorithm on the stereoscopic content prior to encoding the offset sampling may greatly improve the image quality by properly anti-aliasing the data stream before the decimation occurs. Thus, various embodiments may render three-dimensional images with superior image quality. Various applications may benefit from these generalized principles, as explained further with reference to FIG. 3.

FIG. 3 is a block diagram illustrating an alternative display system 300 operable to render a stereoscopic display using a variety of inputs according to one embodiment of the present disclosure. Display system 300 generally includes shutter glasses 204, gaming machines 302 (e.g., Microsoft™ X-box), a computer console 304, a high-definition television (HDTV) 306, and a digital versatile disc (DVD) player 308, all in communication with a dongle 310; however, any suitable display technology may be used to communicate with dongle 310.

Dongle 310 generally refers to any apparatus operable to capture and reformat various industry approaches for transporting or communicating stereographic data. In some embodiments, the reformatting may be effected by a processor located within dongle 310 that is substantially similar in structure and function to processor 202 of FIG. 3. In some such embodiments, the processor may also perform any desired spatial processing prior to creating the format such as scaling, sharpening, or anti-aliasing by having the knowledge of the desired output format for those calculations. For example, a processor within dongle 310 can take two 1920×1080 (left and right) video streams and perform both an anti-aliasing operation and an offset sampling of stereoscopic images in order to yield an appropriate format for use in SmoothPicture™.

In an alternative embodiment, this reformatting capability can be embedded, for example, into HDTV 308 or a projector (not explicitly shown) rather than dongle 310. This embedded reformatting capability may be effected either through an additional component, or future integration with an application specific integrated circuit (ASIC).

In some embodiments, dongle 310 may have universal input capability. For example, dongle 310 may accept DLP® three-dimensional, line interleaved, column interleaved, and frame interleaved formats. In other words, dongle 310 may accept all formats. In implementation, the universal input can be within dongle 310. Alternatively, this universal input can be integrated into the television architecture, such as the engine or front engine. For example, an algorithm can be added to the front engine or television engine through modifications of hardware and firmware. Other qualities of the universal input can include SmoothPicture™ and orthogonal stereoscopic rendering capabilities. In addition, the universal input can have an unlimited number of content possibilities.

For the sake of illustration only, some sample demonstration platforms are described. One skilled in the art will appreciate that there can be numerous variations of these platforms without departing from the scope of the present disclosure. Some light engines that can be used are as follows: a Young Optics xHD5 engine, two TI Dual DDP3021 xHD4 laboratory engines with different color wheels, a Toshiba xHD5 TV, and a Samsung xHD5 television. Such light engines may utilize, for example, an added connection to a processor 202 control signal to drive an external purchased glasses 204 and associated IR emitter module. Moreover, various types of demonstration content can be used. For example, stereo cinematic content can be preprocessed off-line to create the checkerboard format and perform the anti-aliasing filter. This content can be played back real-time on a very fast video server. Alternatively, the engines can be connected to a gaming PC using any video card with a special stereo driver. This driver can be used to create the above-mentioned checkerboard format. Further implementations can result from integrating functionality into an external dongle, a separate ASIC, or a new formatter ASIC.

It will be appreciated that the generalized principles of the present disclosure may use the time-sequenced display of dual images to generate two unrelated video streams to respective users, or a dual-view display. This capability can enable a mode of gaming, for example, where two players can have different perspectives of the action, like from the offensive or defensive line of a football game. This dual view may be effected, for example, by synchronizing both shutters 216 and 218 of a particular pair of glasses 204 to a respective one of the dual images. In this manner, two different viewers may simultaneously watch different video stream content on the same display surface 206.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as falling within the spirit and scope of the appended claims.

What is claimed is:

1. A method of data processing, comprising:
receiving data representing a left image and a right image;
formatting the data into a data stream that alternates sampling between pixels of the left image and pixels of the right image;
providing the data stream to a processor;
receiving the data stream by the processor;
aggregating, from the data stream, pixels of the left image to form a left image;
aggregating, from the data stream, pixels of the right image to form a right image; and
sequentially displaying the left image and the right image.

2. The method of claim 1, and further comprising offsetting the sequential display of the left image and the right image.

3. The method of claim 2, wherein;
the left image and the right image each comprise an array of pixel elements; and
offsetting the sequential display of the left image and the right image comprises offsetting the display by a distance that is less than the width of a pixel element.

4. The method of claim 2, and further comprising offsetting the sequential display of the left image and the right image by an optical actuator.

5. The method of claim 4, wherein the optical actuator comprises a mirror.

6. The method of claim 4, wherein the optical actuator comprises an acoustooptic cell.

7. The method of claim 1, wherein providing the data stream to a processor comprises providing the data stream using an interface selected from the group consisting of:
DVI;
HDMI;
LVDS;
DisplayPort;
SDI;
SCART; and
iTMDS.

8. A method of displaying, comprising:
alternating, on a display, a first image and a second image, each of the first and second images corresponding to a respective array of pixels on the display such that the first image is offset from the second image by less than a pixel width; and
filtering a portion of the light provided from the display in sequence with the alternating of the first image and the second image.

9. The method of claim 8, wherein the first image and the second image correspond respectively to left and right perspectives of a stereoscopic image.

10. The method of claim 8, wherein filtering a portion of the light provided from the display comprises providing light from the display to both eyes of a user corresponding only to the first image and shuttering light from the display corresponding to the second image.

11. The method of claim 8, wherein offsetting the display comprises directing light using a moveable mirror.

12. The method of claim 8, wherein offsetting the display comprises diffracting light using an acoustooptic cell.

13. The method of claim 8, wherein filtering a portion of the light provided from the display comprises shuttering a portion of the light using shutter glasses.

14. A display system, comprising:
a processor operable to:
send a first signal that alternates, on a display, left and right perspectives of an image;
send a second signal for receipt by a shutter device, the second signal synchronized with the first signal; and
send a third signal for receipt by an optical actuator, the third signal synchronized with the first signal.

15. The display system of claim 14, and further comprising a shutter device comprising left and right eyepieces and operable to selectively shutter the left and right eyepieces in response to the second signal.

16. The display system of claim 15, wherein the shutter device comprises a shutter mechanism selected from the group consisting of:
a mechanical shutter;
an electromechanical shutter;
an electrical optical shutter.

17. The display system of claim 16, wherein the shutter device comprises liquid crystal shutter glasses.

18. The display system of claim 14, and further comprising an optical actuator operable to offset, on a display, the left and right perspectives of an image in response to the third signal.

19. The display system of claim 18, wherein the optical actuator comprises a moveable mirror.

20. The display system of claim 18, wherein the left and right perspectives each correspond to a respective array of pixels on the display such that the left perspective is offset from a right perspective by a distance that is less than a pixel width.
